(19) United States
(12) Patent Application Publication
(10) Pub. No.: US 2005/0228737 A1
(43) Pub. Date: Oct. 13, 2005

(54) Semiconductor manufacturing capacity features exchange system

(75) Inventor: Chung-Chien Fang, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/809,985

(22) Filed: Mar. 26, 2004

(51) Int. Cl. G06F 17/60

(52) U.S. Cl. 705/37

(57) ABSTRACT

A method for exchange of futures options through a semiconductor manufacturing environment. In one embodiment, a method is provided for establishing a virtual fab with a plurality of entities, each entity associated with an internal process to a semiconductor fab or an external process to the semiconductor fab. A futures capacity exchange is established through the plurality of entities of the virtual fab. A foundry may establish futures capacity contracts through the futures capacity exchange, wherein a market is provided for trading futures capacity contracts through the futures capacity exchange.

### FIELD OF DISCLOSURE

The present disclosure relates generally to the field of semiconductor manufacturing and, more particularly, to a system and method for the exchange of semiconductor manufacturing capacity futures.

### BACKGROUND

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process.

Furthermore, as the IC industry has matured, the various operations needed to produce an IC can be performed at different locations by a single company or by different companies that specialize in a particular area. This further increases the complexity of producing ICs, as companies and their customers can be separated not only geographically, but also by time zones, making effective communication more difficult. For example, a first company (e.g., an IC design house) can design a new IC, a second company (e.g., an IC foundry) can provide the processing facilities used to fabricate the design, and a third company may assemble and test the fabricated IC. A fourth company may handle the overall manufacturing of the IC, including coordination of the design, processing, assembly, and testing operations.

The complexity of process steps and the time-consuming process of manufacturing advanced semiconductor devices mandates efficient processing systems and methods. The equipment, facilities, and resources required for advanced semiconductor device manufacturing necessitate a substantial financial investment in order to manufacture leading edge complex semiconductor devices. Fewer and fewer companies cannot afford to make an investment for advanced manufacturing facilities, therefore companies with large resources can invest in cutting edge semiconductor process and facility technology for high volume manufacturing. The large company manufacturers of a plurality of complex semiconductor devices are often referred to as foundries. The foundry can provide manufacturing capacity to a plurality of customers, however it is a challenge for the foundry to predict manufacturing capacity and the financial cost of providing the manufacturing capacity.

Accordingly, what is needed is a system and method for the exchange of semiconductor manufacturing capacity futures.

### BRIEF DESCRIPTION OF THE DRAWINGS

FIG. 1 illustrates a futures capacity exchange system for semiconductor manufacturing resources.

FIG. 2 illustrates a virtual IC fabrication system that can benefit from one embodiment of the present disclosure.

FIG. 3 illustrates another embodiment of the virtual fab which includes a plurality of entities of FIG. 2.

FIG. 4 illustrates a system of the semiconductor manufacturing futures capacity exchange which includes a plurality of entities of FIG. 2.

FIG. 5 illustrates a method for implementing a semiconductor futures capacity exchange system.

FIG. 6 illustrates an interface that demonstrates one way by which a customer, investor, or trader may interact with the semiconductor futures capacity exchange system of FIG. 1.

### DETAILED DESCRIPTION

The present disclosure relates generally to the field of semiconductor manufacturing and, more particularly, to a system and method for the exchange of semiconductor manufacturing capacity futures. It is understood, however, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

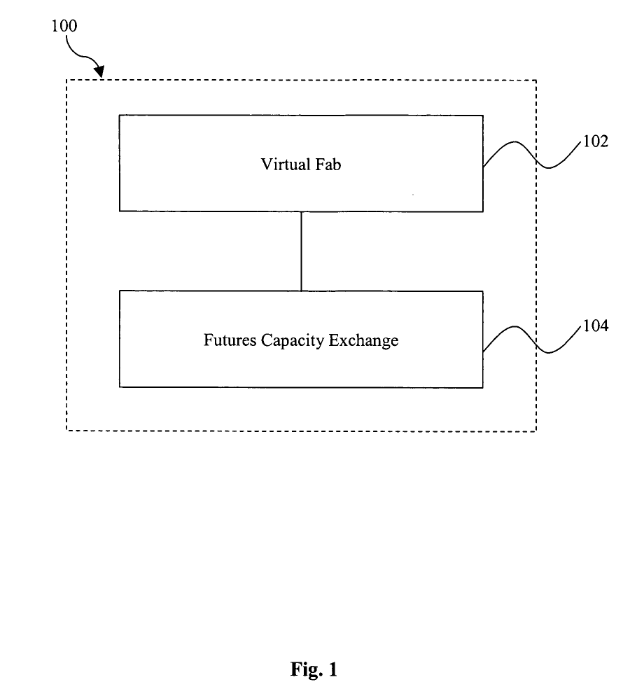

Referring to FIG. 1, in one embodiment, a system 100 for the exchange of semiconductor manufacturing capacity futures is provided. The system 100 may include at least two components 102 and 104. Component 102 represents a virtual IC fabrication system (a “virtual fab”). Component 104 represents a semiconductor manufacturing capacity futures exchange. The semiconductor manufacturing capacity futures exchange 104 includes a plurality of entities for creating options based upon manufacturing capacity, assigning options as futures, and implementing an exchange system of privately or publicly held futures options. The semiconductor manufacturing capacity futures exchange 104 may provide a vehicle across all embodiments of the virtual fab 102 by which a plurality of customers, investors, or traders may trade capacity futures through a private or open financial market. The semiconductor manufacturing capacity futures exchange 104 may employ methods and systems which may be shared among customers, foundries, assembly facilities, sub-contractors, and other entities. Interaction with the semiconductor manufacturing capacity futures exchange 104 may be performed through the virtual fab component 102. For example, a customer may purchase an option from the foundry for a future capacity. The option or futures contract may provide the customer with the privilege of utilizing the manufacturing capacity of the foundry at a future date corresponding to the number and size of the purchased capacity futures contracts. The futures contracts may have assigned expiration dates wherein the manufacturing capacity of the futures contract becomes available to the futures contract holder(s). The future contracts may be traded privately or publicly through the virtual fab 102 by the semiconductor manufacturing capacity futures exchange 104. The foundry may issue additional capacity futures contracts or reduce the total number of futures contracts. The foundry may influence the value of capacity future contracts traded in the semiconductor manufacturing capacity futures exchange 104. Moreover, the semiconductor manufacturing capacity futures exchange 104 may provide real-time feedback of futures price and trading information through the virtual fab 102.

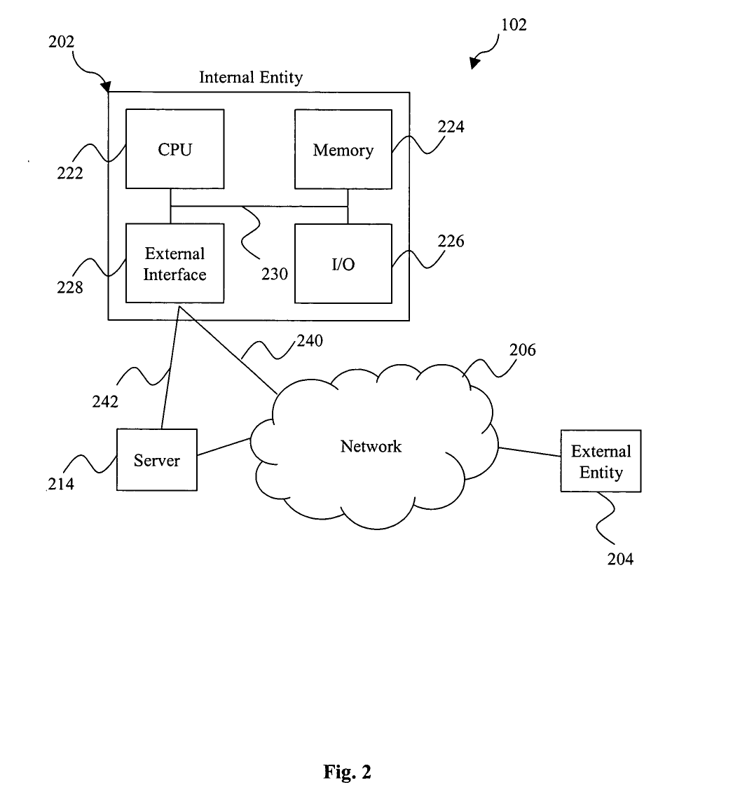

Referring now to FIG. 2, one embodiment of the virtual fab 102 includes a plurality of entities, represented by one or more internal entities 202 and one or more external entities 204 that are connected by a communications network 206. The network 206 may be a single network or may be a variety of different networks, such as an intranet and the Internet, and may include both wireline and wireless communication channels.

Each of the entities 202, 204 may include one or more computing devices such as personal computers, personal digital assistants, pagers, cellular telephones, and the like. For the sake of example, the internal entity 202 is expanded to show a central processing unit (CPU) 222, a memory unit 224, an input/output (I/O) device 226, and an external interface 228. The external interface may be, for example, a modem, a wireless transceiver, and/or one or more network interface cards (NICs). The components 222-228 are interconnected by a bus system 230. It is understood that the internal entity 202 may be differently configured and that each of the listed components may actually represent several different components. For example, the CPU 222 may actually represent a multi-processor or a distributed processing system; the memory unit 224 may include different levels of cache memory, main memory, hard disks, and remote storage locations; and the I/O device 226 may include monitors, keyboards, and the like.

The internal entity 202 may be connected to the communications network 206 through a wireless or wired link 240, and/or through an intermediate network 242, which may be further connected to the communications network. The intermediate network 242 may be, for example, a complete network or a subnet of a local area network, a company wide intranet, and/or the Internet. The internal entity 202 may be identified on one or both of the network(s) 240-242 by an address or a combination of addresses, such as a media control access (MAC) address associated with the network interface 228 and an internet protocol ('P) address. Because the internal entity 202 may be connected to the intermediate network 242, certain components may, at times, be shared with other internal entities. Therefore, a wide range of flexibility is anticipated in the configuration of the internal entity 202. Furthermore, it is understood that, in some implementations, a server 214 may be provided to support multiple internal entities 202. In other implementations, a combination of one or more servers and computers may together represent a single entity.

In the present example, the internal entities 202 represents those entities that are directly responsible for producing the end product, such as a wafer or individually tested IC devices. Examples of internal entities 202 include an engineer, customer service personnel, an automated system process, a design or fabrication facility and fab-related facilities such as raw-materials, shipping, assembly or test. Examples of external entities 204 include a customer, a futures trader or investor, a design provider; and other facilities that are not directly associated or under the control of the fab. In addition, additional fabs and/or virtual fabs may be included with the internal or external entities. Each entity may interact with other entities and may provide services to and/or receive services from the other entities.

It is understood that the entities 202, 204 may be concentrated at a single location or may be distributed, and that some entities may be incorporated into other entities. In addition, each entity 202, 204 may be associated with system identification information that allows access to information within the system to be controlled based upon authority levels associated with each entities identification information.

The virtual fab 102 enables interaction among the entities 202, 204 for purposes related to IC manufacturing, as well as the provision of services. In the present example, IC manufacturing may include one or more of the following steps:
receiving or modifying purchases of the available semiconductor capacity futures contracts;
receiving or modifying the number of the available semiconductor capacity futures contracts;
receiving or modifying a customer's IC order of price, delivery, and/or quantity;
receiving or modifying an IC design;
receiving or modifying a process flow;
receiving or modifying a circuit design;
receiving or modifying a mask change;
receiving or modifying testing parameters;
receiving or modifying assembly parameters; and
receiving or modifying shipping of the ICs.

One or more of the services provided by the virtual fab 102 may enable collaboration and information access in such areas as design, engineering, and logistics. It is noted that entity 204 make take several forms including customers, engineers, and design facilities as noted below. For example, in the design area, the customer represented by entity 204 may be given access to information and tools related to the design of their product via fab represented by entity 202. The tools may enable the customer entity 204 to perform yield enhancement analyses, view layout information, and obtain similar information. In the engineering area, an engineer entity 204 may collaborate with another engineer entity 204 using fabrication information regarding pilot yield runs, risk analysis, quality, and reliability. A logistics area (not shown) may provide the customer entity 204 with fabrication status, testing results, order handling, and shipping dates. It is understood that these areas are exemplary, and that more or less information may be made available via the virtual fab 102 as desired.

Another service provided by the virtual fab 102 may integrate systems between facilities, such as between a entity 204 and the fab facility entity 202. Such integration enables facilities to coordinate their activities. For example, integrating a design facility entity and a fab facility entity into an integrated entity 204 may enable design information to be incorporated more efficiently into the fabrication process, and may enable data from the fabrication process to be returned to the design facility entity for evaluation and incorporation into later versions of an IC.

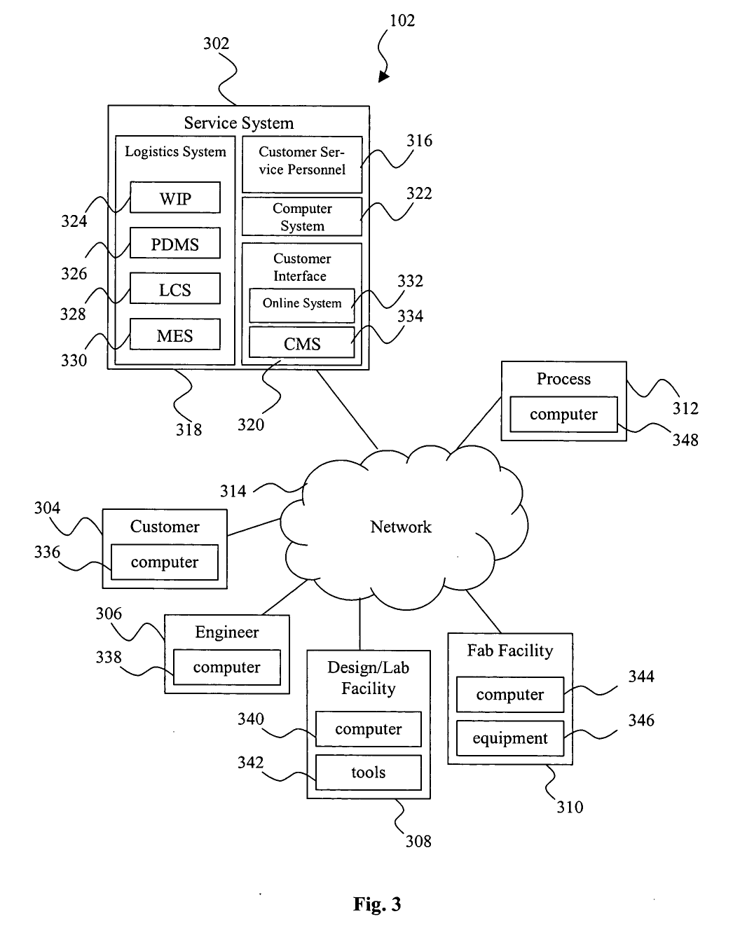

Referring now to FIG. 3, another embodiment of the virtual fab 102 includes a plurality of entities 302-312 that are connected by a communications network 314. In the present example, the entity 302 represents a service system, the entity 304 represents a customer, the entity 306 represents an engineer, the entity 308 represents a design/lab facility for IC design and testing, the entity 310 represents a fab facility, and the entity 312 represents a process (e.g., an automated fabrication process) either inside the fab 310, or at another facility. Each entity may interact with other entities and may provide services to and/or receive services from the other entities.

The service system 302 provides an interface between a customer's internal system (e.g., a computer database) and the IC manufacturing operations. For example, the service system 302 may include customer service personnel 316, a logistics system 318 for order handling and tracking, and a customer interface 320 for enabling a customer to directly access various aspects of an order.

The logistics system 318 may include a work-in-process (WIP) inventory system 324, a product data management system 326, a lot control system 328, and a manufacturing execution system (MES) 330. The WIP inventory system 324 may track working lots using a database (not shown). The product data management system (PDMS) 326 may manage product data and maintain a product database (not shown). The product database could include product categories (e.g., part, part numbers, and associated information), as well as a set of process stages that are associated with each category of products. The lot control system (LCS) 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 302 and outside of the service system 302. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer interface 320 may include an online system 332 and an order management system (CMS) 334. The online system 332 may function as an interface to communicate with the customer 304, such as through email or other electronic means. The online system 332 may also function as an interface to other systems within the service system 302, supporting databases (not shown), and other entities 306-312. The order management system 334 may manage client orders and may be associated with a supporting database (not shown) to maintain client information and associated order information.

Portions of the service system 302, such as the customer interface 320, may be associated with a computer system 322 or may have their own computer systems. In some embodiments, the computer system 322 may include multiple computers, some of which may operate as servers to provide services to the customer 304 or other entities. The service system 302 may also provide such services as identification validation and access control, both to prevent unauthorized users from accessing data and to ensure that an authorized customer may access only their own data.

The customer 304 may obtain information about the manufacturing of its ICs via the virtual fab 102 using a computer system 336. In the present example, the customer 304 may access the various entities 302, 306-312 of the virtual fab 102 through the customer interface 320 provided by the service system 302. However, in some situations, it may be desirable to enable the customer 304 to access other entities without going through the customer interface 320. For example, the customer 304 may directly access the fab facility 310 to obtain fabrication related data.

The engineer 306 may collaborate in the IC manufacturing process with other entities of the virtual fab 102 using a computer system 338. The virtual fab 102 enables the engineer 306 to collaborate with other engineers and the design/lab facility 308 in IC design and testing, to monitor fabrication processes at the fab facility 310, and to obtain information regarding test runs, yields, etc. In some embodiments, the engineer 306 may communicate directly with the customer 304 via the virtual fab 102 to address design issues and other concerns.

The design/lab facility 308 provides IC design and testing services that may be accessed by other entities via the virtual fab 102. The design/lab facility 308 may include a computer system 340 and various IC design and testing tools 342. The IC design and testing tools 342 may include both software and hardware.

The fab facility 310 enables the fabrication of ICs. Control of various aspects of the fabrication process, as well as data collected during the fabrication process, may be accessed via the virtual fab 102. The fab facility 310 may include a computer system 344 and various fabrication hardware and software tools and equipment 346. For example, the fab facility 310 may include an ion implantation tool, a chemical vapor deposition tool, a thermal oxidation tool, a sputtering tool, and various optical imaging systems, as well as the software needed to control these components.

The process 312 may represent any process or operation that occurs within the virtual fab 102. For example, the process 312 may be an order process that receives an IC order from the customer 304 via the service system 302, a fabrication process that runs within the fab facility 310, a design process executed by the engineer 306 using the design/lab facility 308, or a communications protocol that facilities communications between the various entities 302-312.

It is understood that the entities 302-312 of the virtual fab 102, as well as their described interconnections, are for purposes of illustration only. For example, it is envisioned that more or fewer entities, both internal and external, may exist within the virtual fab 102, and that some entities may be incorporated into other entities or distributed. For example, the service system 302 may be distributed among the various entities 306-310.

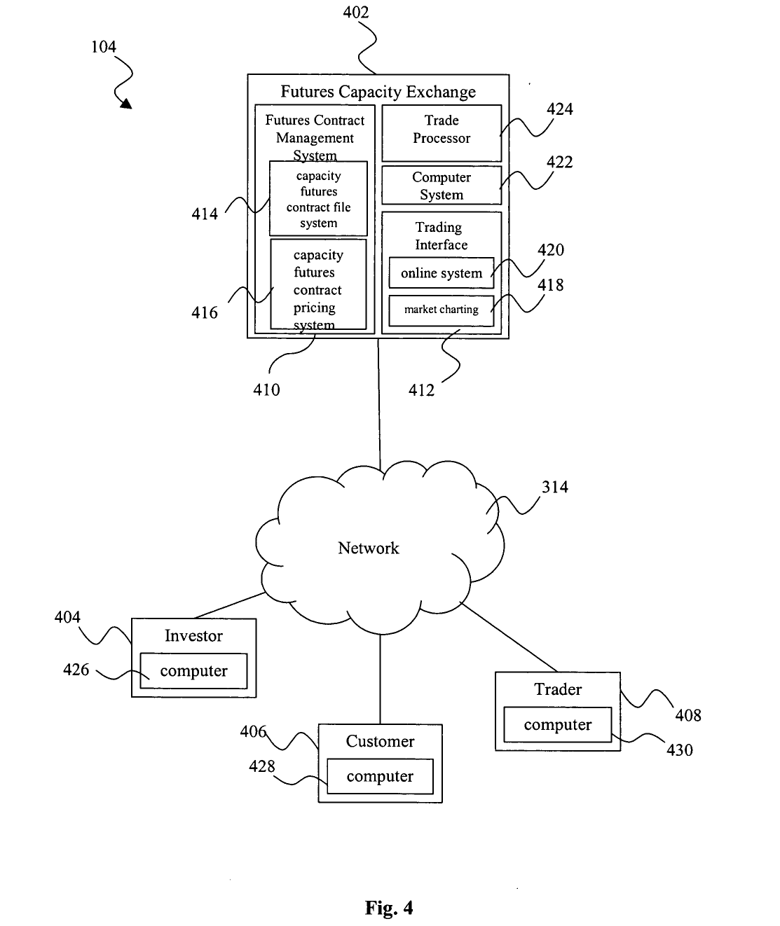

Referring now to FIG. 4, in another embodiment, a system 400 further illustrating the semiconductor manufacturing futures capacity exchange 402 which includes a plurality of entities 402, 420, 424, and 428. In the present example, the entity 402 represents a semiconductor manufacturing futures capacity exchange, the entity 404 represents an investor, the entity 406 represents a customer, and the entity 408 represents a trader. Each entity may interact with other entities and may provide services to and/or receive services from the other entities through the network 314 of the virtual fab 102.

The semiconductor manufacturing futures capacity exchange 402 provides an interface between a customer's internal system (e.g., a computer database) and other internal entities. For example, the semiconductor manufacturing futures capacity exchange 402 may include a trade processor 424, a futures contract management system 410, and a computer system 422, and a trading interface 412 for enabling a customer to directly access various aspects of the semiconductor manufacturing futures capacity exchange 402. The trade processor 424 may include any methods for computing real-time capacity future contract bid and ask prices, the amount of available capacity futures contracts, and the management of applicable rules governing the semiconductor manufacturing futures capacity exchange 402.

The futures contract management system 410 may include a capacity futures contract file system 414 and a capacity futures contract pricing system 416. The capacity futures contract file system 414 may track the ownership of capacity futures contracts, the amount, the expiration dates, and the trading activity of the capacity futures contracts. The capacity futures contract pricing system 416 may determine the value of the capacity futures contracts based upon financial market conditions including capacity demand, product type, single product on single wafer, multiple project wafer, the available capacity futures contracts, and any other value influencing factors.

The trading interface 412 may include an online system 418 and semiconductor manufacturing futures capacity market charting system 420. The online system 418 may function as an interface to communicate with the investor 404, customer 406, and trader 408 such as through email and/or other electronic means. The online system 418 may also function as an interface to other systems within the semiconductor manufacturing futures capacity exchange 402, supporting databases (not shown), and other entities 306-312. The capacity futures market charting system 420 may display client trading activity and may be associated with a supporting database (not shown) to maintain client information and associated order information. Portions of the semiconductor manufacturing futures capacity exchange 402, such as the trading interface 412, may be associated with a computer system 422 or may have their own computer systems.

The investor 404, customer 406, and trader 408 may obtain information about the manufacturing of its ICs, the manufacturing capacity, and the value of capacity futures contracts via the virtual fab 102 using computer system(s) 426, 428, and 430. In the present example, the investor 404, customer 406, and trader 408 may access the various entities 402, 404-408 of the virtual fab 102 through the trading interface 412 provided by the semiconductor manufacturing futures capacity exchange 402. However, in some situations, it may be desirable to enable the investor 404, customer 406, and/or trader 408 to access other entities without interfacing the trading interface 412. For example, the investor 404, customer 406, and/or trader 408 may directly access the fab facility 310 or futures contract management system 410 to obtain fabrication related data, financial statements, and available manufacturing capacity. Manufacturing entities may provide status of available manufacturing capacity to the semiconductor manufacturing futures capacity exchange 402 wherein the investor 404, customer 406, and/or trader 408 may be given knowledge of the available manufacturing capacity.

It is understood that the entities 402, 404-408 coupled to the virtual fab 102 through the network 314, as well as their described interconnections, are for purposes of illustration only. For example, it is envisioned that more or fewer entities, both internal and external, may exist within the virtual fab 102, and that some entities may be incorporated into other entities or distributed. For example, the semiconductor manufacturing futures capacity exchange 402 may be distributed among the various entities 402-408.

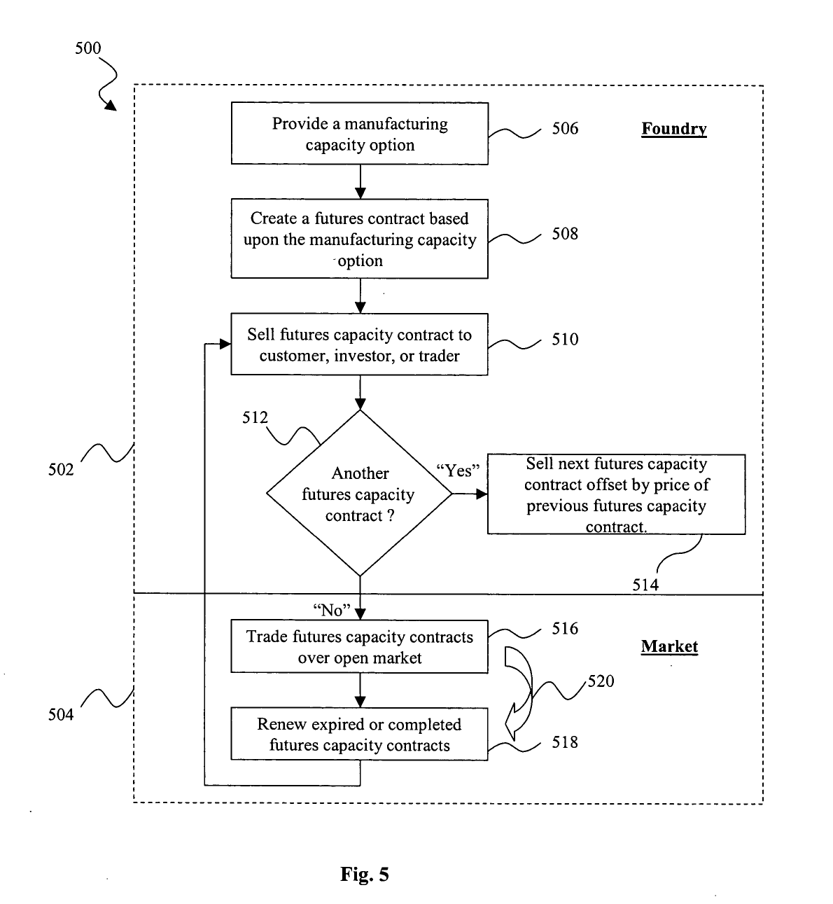

Referring now to FIG. 5, a flowchart is shown illustrating a method 500 for implementing the futures capacity exchange 104 of FIG. 1. The method 500 may be implemented through the futures capacity exchange 402 coupled to virtual fab 102. The method 500 may be sub-divided into processes that may be performed by the foundry 502, the market 504, or by both foundry 502 and the market 504. The foundry 502 may include any mass production semiconductor manufacturing facility wherein complex semiconductor devices may be fabricated completely or partially prior to being packaged by another entity. The foundry 502 may be connected to a plurality of entities through a network 314 comprising the virtual fab 102. The market 504 represents all entities which may interact with the futures capacity exchange 104 which may include the investor 404, the customer 406, the trader 408, and any internal entities 202 or other external entities 216. The market 504 may be influenced by a plurality of external and internal events such as changes in product demand, capacity futures contract ownership change and demand, and many other financial and/or infrastructural factors.

The method 500 of the futures capacity exchange 104 system may be initiated by a process 506 wherein the foundry 502 provides a manufacturing capacity option. The total manufacturing capacity or total capacity unused may be partitioned into a plurality of options. The options grant ownership or privilege of manufacturing capacity. The options may represent a specified percentage of capacity ownership and may expire at a specified date at which the option may be executable. For example, the foundry 502 may have 40% of unutilized manufacturing capacity. The unutilized capacity may be partitioned into options with a capacity ownership of 1% therefore there may be about forty options. Specific options may not have an expiration date and therefore would enable a investor 404 or customer 406 long-term manufacturing capacity ownership. Therefore, permanent manufacturing capacity ownership may be held by an investor 404 or customer 406, however the amount of permanent options held by the investor 404 or customer 406 may be further dictated by the foundry 502 or market 504. The value of the option may be dictated by the foundry 502, the market 504, and a plurality of other factors wherein the value may change.

Next, moving to process 508, the foundry 502 may create a futures contract based upon the manufacturing capacity option. The futures contract may include the capacity option wherein an expiration date may be assigned. The futures contract may enable the owner with the right to utilized manufacturing capacity according to the value of the futures options held by the investor 404, customer 406, and/or trader 408. The futures contract may allow the holder the ownership of the foundry 502 manufacturing capacity which may include process equipment resources, electronic design resource, and packaging resources. The futures contract may allow only the right to access the foundry 502 manufacturing capacity for a specified range of time or after an expired date. Alternatively, the futures contract may only allow the holder access to the owned capacity and may further pay the foundry the costs of design and manufacturing. The capacity could include manufacturing on a plurality of semiconductor wafers or multiple project wafers wherein multiple futures contract holders may manufacture upon the same plurality of wafers. The capacity could further include manufacturing on a plurality non-conventional substrates or multiple project substrates wherein multiple futures contract holders may manufacture upon the same plurality of substrates. The futures contract may be sold by the foundry according to process 510 to a plurality of investor(s) 404, customer(s) 406, and trader(s) 408. The future contracts may be distributed and/or sold to investor(s) 404, customer(s) 406, and trader(s) 408 until a pre-determined amount of available future contracts are sold. Process 512 may provide determination if more future contracts may be created. In the case where no further future contracts are created, trade may continue to occur by process 516 in the market 504. At process 514, new future contracts may be created by the foundry 502 wherein the price or value of the new future contracts may be offset by the price of the previous capacity futures contracts. New capacity futures contracts may be created due to the addition of manufacturing capacity and/or due to a shortage of existing futures contracts.

The futures contracts may be privately or openly traded on the market 504 by a plurality of investor(s) 404, customer(s) 406, and trader(s) 408 by step 516. The value of capacity futures contracts may dynamically change according to market conditions. Capacity futures contracts may be traded or held until the specified expiration date for the specific capacity futures contract. Once the specific capacity futures contract expires, the capacity futures contract may be renewed and sold to a plurality of investor(s) 404, customer(s) 406, and trader(s) 408 at process 518. The issuing or renewal of capacity futures options may automatically occur and may be executed by the computer system 422 of the semiconductor manufacturing futures capacity exchange 402. The processes 516 and 518 may be cyclical and process 504 may be coupled to process 510 wherein the foundry 502 may issue or sell capacity futures contracts to the investor(s) 404, customer(s) 406, and trader(s) 408.

At any given time the foundry 502 may issue additional futures capacity contracts into the market 504 which may be caused by the addition of manufacturing capacity such as addition process equipment to an existing semiconductor manufacturing facility and the addition of new semiconductor manufacturing facilities. Futures capacity contracts may be withdrawn from the market 504 due to reduction of semiconductor manufacturing capacity or any other reason set forth by the foundry 502.

It is understood that the method 500 may be used in conjunction with virtual fab 102. It is envisioned that more or fewer processes, both internal and external of the foundry 502 and/or the market 504, may exist within the foundry 502 and the market 504, and that some processes may be incorporated into other processes or distributed. For example, the trade of futures capacity process 516 may be distributed among the various processes of the foundry 502 and the market 504. The trade of futures capacity process 516 may be distributed among the various external entities 204, including a “world-wide open” market 504 and a plurality of foundries 502 located at various locations over the world.

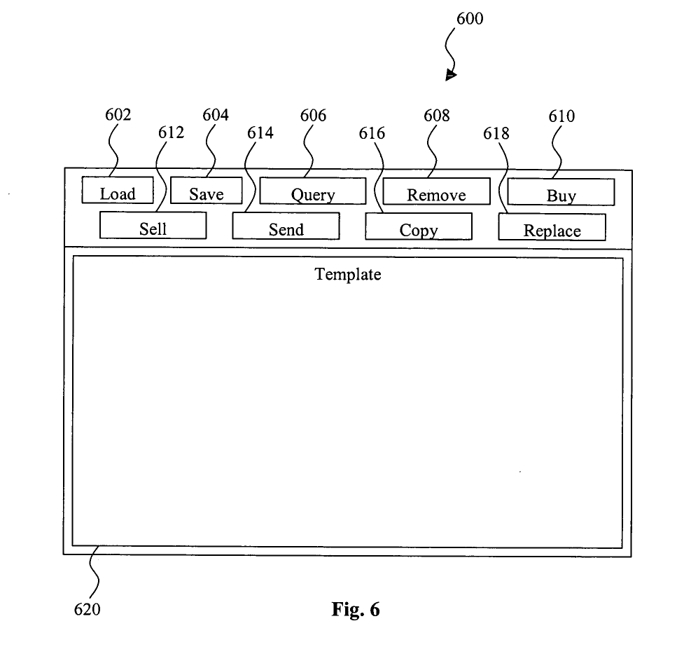

Referring now to FIG. 6, an interface 600 illustrates one means by which internal entities 202 and external entities 204 may interact with the semiconductor manufacturing futures capacity exchange 104 of FIG. 1. It is understood that a variety of interfaces may be presented to the investor(s) 404, customer(s) 406, and trader(s) 408, such as a login interface and a help interface that provides the investor 404, customer 406, and/or trader 408 with instructions on how to accomplish various tasks. After the investor 404, customer 406, and/or trader 408 login to the semiconductor manufacturing futures capacity exchange 104, the interface 600 presents the investor 404, customer 406, and/or trader 408 with several options. In the present example, the interface 600 includes a Load button 602, a Save button 604, an Query button 606, a Remove button 608, a Buy button 610, a Sell button 612, a Send button 614, a Copy button 616, and a Replace button 618. The interface 600 may also include a template 620 that provides the investor 404, customer 406, and/or trader 408 with a information regarding foundry 502 manufacturing capacity, real-time value of futures capacity contracts, manufacturing capacity forecasts/reports, and trading activity of the futures capacity contracts status. The template 620 may be updated by the investor 404, customer 406, foundry 502 and/or trader 408. Alternatively, the semiconductor manufacturing futures capacity exchange 104 may be applied to the template 620 wherein the semiconductor manufacturing futures capacity exchange 402 and the method 500 may be visualized and amended. The template 620 may further represent a browser screen, a plurality of selection screens, and a real-time tracking/control screen through the semiconductor manufacturing futures capacity exchange 104.

The Load and Save buttons 602, 604 provide the investor 404, customer 406, and/or trader 408 with the option to either loading manufacturing capacity data and information built-in from the foundry 502, the market 504 and the semiconductor manufacturing capacity futures exchange 104 through the virtual fab 102. The Query button 606 may search for foundry 504 manufacturing capacity information, futures capacity values, and other financial specification databases. The Remove button 608 enables the investor 404, customer 406, and/or trader 408 to remove information from the semiconductor manufacturing capacity futures exchange 104. The Buy button 610 enables the investor 404, customer 406, and/or trader 408 to execute buy orders in the market 504 for the purchase of futures capacity contracts. The Sell button 612 enables the investor 404, customer 406, and/or trader 408 to execute sell orders in the market 504 for the liquidation of futures capacity contracts through the semiconductor manufacturing capacity futures exchange 104. The Buy button 610 and the Sell button 612 may be automatically activated wherein user interface 600 may not be required, and trading of futures capacity may be controlled by statistical trending analysis and variations in trading activity that occur in the market 504 of the semiconductor manufacturing capacity futures exchange 104.

The Send button 614 may enable the sending and receiving of email notifications from the semiconductor manufacturing capacity futures exchange 104. The Copy button 616 may enable the investor 404, customer 406, and/or trader 408 to duplicate data and information a plurality of databases within the network 314 (e.g., financial reports, manufacturing capacity forecasts, proxies, etc.). The Replace button 618 may enable a selected component of information to be replaced by another component of information.

It is understood that the buttons and functions are illustrative, and that many other buttons and functions may be provided. For example, a context sensitive menu may be activated by clicking on a mouse button (not shown) or by using a keyboard (not shown). Accordingly, the interface 600 may be altered as desired to extend its functionality and to maximize investor 404, customer 406, and/or trader 408 support.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

1. A semiconductor futures exchange system comprising:
a virtual semiconductor fabrication facility (virtual fab) which provides information regarding fabrication of semiconductor devices in the virtual fab; and
a semiconductor futures exchange coupled to the virtual fab to receive the information, the semiconductor futures exchange offering semiconductor futures for sale based on the information.

2. The semiconductor futures exchange system of claim 1 wherein the information includes capacity contracts for the right to utilize manufacturing capacity.

3. The semiconductor futures exchange system of claim 1 wherein the information includes work in progress (WIP) of the virtual semiconductor fabrication facility.

4. The semiconductor futures exchange system of claim 1 wherein the semiconductor futures exchange is a semiconductor futures capacity exchange.

5. The semiconductor futures exchange system of claim 1 wherein the virtual fab includes a semiconductor foundry.

6. The semiconductor futures exchange system of claim 1 further comprising at least one entity adapted for communicating between a computer system associated with the semiconductor futures exchange and a computer system associated with the virtual semiconductor fabrication facility.

7. The semiconductor futures exchange system of claim 1 further comprising a manufacturing executing system used to facilitate production in the virtual semiconductor fabrication facility.

8. The semiconductor futures exchange system of claim 1 further comprising at least one entity associated with a specific process within the virtual semiconductor fabrication facility.

9. The semiconductor futures exchange system of claim 1 further comprising at least one entity adapted for communicating between a computer system associated with an external service provider and a computer system associated with the semiconductor futures exchange.

10. The semiconductor futures exchange system of claim 9, wherein the external service provider is an investor.

11. The semiconductor futures exchange system of claim 9, wherein the external service provider is a customer.

12. The semiconductor futures exchange system of claim 9, wherein the external service provider is a trader.

13. The semiconductor futures exchange system of claim 1, wherein the virtual semiconductor fabrication facility performs a plurality of processes associated with semiconductor fabrication.

14. The semiconductor futures exchange system of claim 1 wherein the virtual fab includes a semiconductor foundry.

15. The semiconductor futures exchange system of claim 1wherein the semiconductor futures exchange interacts with a plurality of traders.

16. A method of exchanging semiconductor futures comprising:
providing a semiconductor futures exchange;
coupling the semiconductor futures change to a virtual fab; and
interacting with the semiconductor futures exchange through the virtual fab to trade semiconductor futures.

17. The method of claim 16 wherein the interacting with the semiconductor futures exchange relates to purchasing options on the semiconductor futures exchange.

18. The method of claim 16 wherein the interacting with the semiconductor futures exchange relates to selling options on the semiconductor futures exchange.

19. The method of claim 16 wherein a customer interacts with the futures exchange.

20. The method of claim 16 wherein a investor interacts with the futures exchange.

21. The method of claim 16 wherein a trader interacts with the futures exchange.

22. The method of claim 16 wherein the virtual fab includes a plurality of entities.

23. The method of claim 16 wherein the semiconductor futures exchange interfaces via the virtual fab with entities internal to and external to the virtual fab.

24. The method of claim 16 wherein the semiconductor futures exchange is a semiconductor capacity futures exchange.

25. The system of claim 24 wherein the semiconductor capacity futures exchange includes a trade processor for executing trades of semiconductor futures contracts through a market established by the semiconductor futures exchange.
